(19) United States
(12) Patent Application Publication
(10) Pub. No.: US 2003/0076203 A1
(43) Pub. Date: Apr. 24, 2003

(54) Electrical relay contact block and method for the use thereof

(76) Inventor: Craig E. Brooks, Port Byron, IL (US)

Correspondence Address: BRINKS HOFER GILSON & LIONE, P.O. Box 10395, Chicago, IL, 60610, US

(21) Appl. No.: 10/037,419

(22) Filed: Oct. 22, 2001

(51) Int. Cl. H01H 67/02

(52) U.S. Cl. 335/128

(57) ABSTRACT

In one aspect, a contact block for use with an electrical relay includes a grippable portion and a plurality of blocking portions extending from the grippable portion. The plurality of blocking portions are oriented in a parallel relationship relative to each other. The grippable portion and the plurality of blocking portions are substantially coplanar. In another aspect, a control system includes an electrical relay having a base, a contact arrangement supported on the base and a cover moveable between at least a first position, wherein the cover is releasably secured to the base over the contact arrangement, and a second position wherein the cover is disengaged from the base with the contact arrangement exposed to the user. The system further includes a contact block having a primary blocking portion and a secondary blocking portion. The primary blocking portion is releasably inserted into the contact arrangement and the secondary blocking portion is disposed between the cover and the base when said cover is in the second position. The secondary block portion prevents the cover from being moved to the first position. In yet another aspect, a method of blocking an electrical contact arrangement is provided.

### BACKGROUND

The present invention relates generally to electrical relays, and in particular, to a contact block for blocking the contacts on an electrical relay, and to the method for the use thereof.

Control systems are frequently used to control the operation of various components in manufacturing and industrial settings. For example, control systems are used in power plants to start or otherwise actuate diesel generators and other pieces of equipment. Often, it can be necessary to test the various control systems, or the circuitry and software making up the system, to ensure that it is operating properly. For example, after a planned outage in a power plant, or a planned downtime of a manufacturing facility, it is desirable to perform logic testing of the various systems to ensure that they are operating properly before bringing the plants back on line. Frequently, the various control systems incorporate electromagnetic relays or other types of switches. Typically, relays or switches of this type include a contact arrangement including one or more stationary contacts and a moveable contact. In addition, relays and switches of this type often have a cover that can be removed to provide access to the contacts.

Typically, during logic testing, it is necessary to keep the relay energized, so that the testing can be performed. However, at the same time, it can be desirable to maintain the moveable contact in a particular position such that it does not make contact with one of the stationary contacts and thereby inadvertently actuate a piece of equipment. For example, when installing a cover over a relay during logic testing, the operator can, on occasion, inadvertently bump the contact with the cover and thereby initiate an undesirable operating sequence.

As set forth in U.S. Pat. No. 3,231,791, it is known to insert wedges or other blocking devices between the contacts to prevent the movement thereof. However, many relays have barriers between the contact arrangements, thereby making it necessary to install more than one blocking device on each relay. In addition, such blocking devices typically are not sized to prevent the cover from being installed over the relay with the blocking device installed, and are not otherwise provided with indicia advising the operator that the relay is blocked. Accordingly, the cover can be installed inadvertently over the blocked relay.

### SUMMARY

Briefly stated, in one aspect, the invention is directed to a contact block for use with an electrical relay. The contact block includes a grippable portion and a plurality of blocking portions extending from the grippable portion. The plurality of blocking portions are oriented in a parallel relationship relative to each other. The grippable portion and the plurality of blocking portions are preferably substantially coplanar. In a preferred embodiment, the contact block includes a pair of blocking portions, each of which has a tapered end portion. Also in a preferred embodiment, the contact block is made of a pliable material, and more preferably a nonconductive material, such as a plastic.

In another aspect, the contact block is provided with notice indicia, which provides notice to the user or operator that the block is installed in, or is blocking, the contact arrangement. For example, in one preferred embodiment the contact block is configured with a bright color.

In yet another aspect, a control system includes an electrical relay having a base, a contact arrangement supported on the base and a cover moveable between at least a first position, wherein the cover is releasably secured to the base over the contact arrangement, and a second position wherein the cover is disengaged from the base with the contact arrangement exposed to the user. The system further includes a contact block having a primary blocking portion and a secondary blocking portion. The primary blocking portion is releasably inserted into the contact arrangement between the contacts. The secondary blocking portion is disposed between the cover and the base and thereby prevents the cover from being moved to the first position.

In yet another aspect, a method of blocking an electrical contact arrangement includes removing the cover from the base and thereby exposing the contact arrangement. The method further includes releasably inserting the primary blocking portion into the exposed contact arrangement and thereby blocking the contact arrangement from making an electrical connection. The method also includes disposing the secondary blocking portion between the cover and the base wherein the secondary block portion prevents the cover from being releasably secured to the base.

In yet another aspect, another preferred method of blocking an electrical contact arrangement includes releasably inserting at least a pair of a plurality of blocking portions into at least a pair of contact arrangements and thereby blocking the pair of contact arrangements from making an electrical connection.

The contact block, the system incorporating the block and the method for the use thereof, provide significant advantages. For example, in one embodiment of the contact block, which includes a plurality of primary blocking portions, the user can use the contact block to simultaneously block a plurality of contact arrangements. In addition, the indicia provides notice to the user that a contact block is blocking the contact arrangement, such that the user or operator is advised that they should remove the contact block when they are done with the logic testing. Similarly, in another preferred embodiment of the contact block, which includes a secondary blocking portion, the secondary blocking portion prevents the cover from being inadvertently installed with the primary blocking portion still inserted in the contact arrangement.

At the same time, in one preferred embodiment, the substantially coplanar configuration of the contact block, together with its relatively thin profile, allow the cover to be partially installed with the contact block still in place in the contact arrangement. As such, the cover can be partially aligned on the base with the contact block remaining inserted in the contact arrangement. The contact block can then be removed from the contact arrangement, so as to allow the cover to be completely installed without the attendant risk of the cover inadvertently bumping one of the contacts.

The contact block, which is preferably made of a nonconductive material such as plastic, can be manufactured very inexpensively. At the same time, the contact block, and the use thereof, can yield substantial cost savings in various industrial applications using relays or other switching devices using moveable contacts, including for example and without limitation power plants, by preventing inadvertent and unintended actuations of various control systems and/or various associated pieces of equipment.

The present invention, together with further objects and advantages, will be best understood by reference to the following detailed description taken in conjunction with the accompanying drawings.

### BRIEF DESCRIPTION OF THE DRAWINGS

FIG. 1 is a perspective view of an electrical relay with the cover removed.

FIG. 2 is a front view of an electrical relay with the cover removed.

FIG. 3 is a side view of an electrical relay with the cover removed.

FIG. 4 is a perspective view of an electrical relay with a contact block inserted on a first side of a pair of moveable contacts forming a portion of a pair of contact arrangements.

FIG. 5 is a perspective view of an electrical relay with a contact block inserted on a second side of a pair of moveable contacts forming a portion of a pair of contact arrangements.

FIG. 6 is a perspective view of electrical relay with a contact block inserted in a contact arrangement and with a cover partially installed on the relay.

FIG. 7 is a perspective view of electrical relay with a cover completely installed thereon.

FIG. 8 is a perspective view of a first embodiment of a contact block.

FIG. 9 is a perspective view of a second embodiment of a contact block.

### DETAILED DESCRIPTION OF THE PRESENTLY PREFERRED EMBODIMENTS

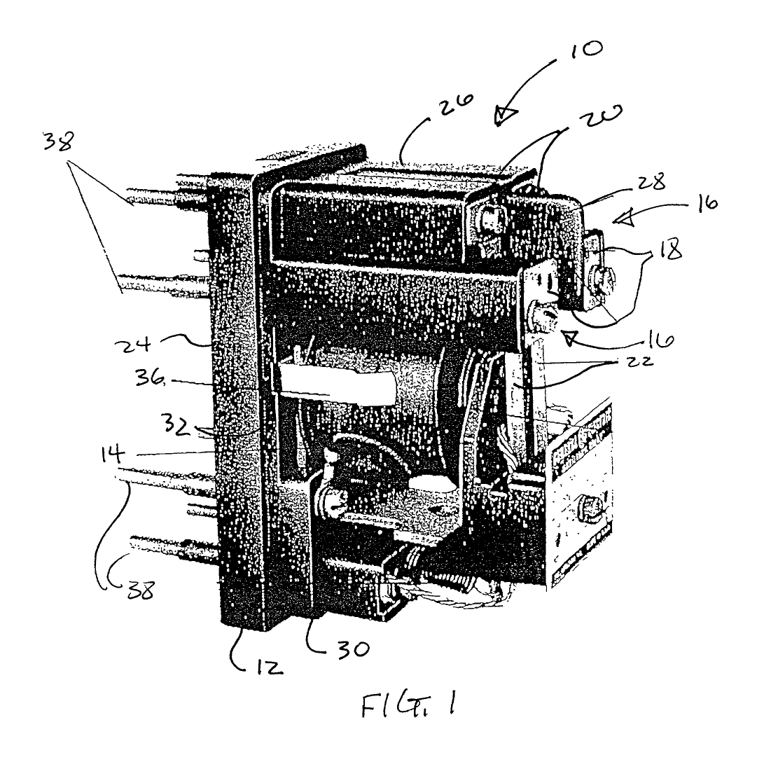

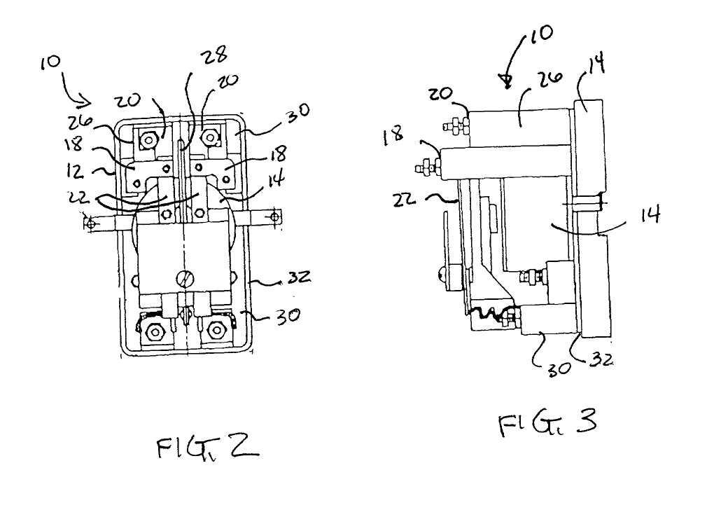

Referring to FIGS. 1-5, an electrical relay 10 is shown as having a base 12, an armature 14, and a plurality, shown as a pair, of contact arrangements 16. It should be understood that the term “plurality” means two or more. It should also be understood that the phrase “electrical relay,” as used herein, generally refers to any device that includes a contact arrangement having a moveable contact, including without limitation electromagnetic devices for remote or automatic control that are actuated by variation in conditions of an electric circuit and that operate in turn other devices, including switches, in the same or a different circuit. In addition, it should be understood that the term “contact arrangement” means two or more contacts that are capable of making an electrical connection.

For example, each contact arrangement 16 shown in FIG. 1 includes a pair of first stationary contacts 18, a pair of second stationary contacts 20 spaced from the first stationary contacts and a pair of moveable contacts 22 capable of making contact with either pair of stationary contacts 18, 20. It should be understood that the relay can be configured with a single contact arrangement, or more than two contact arrangements, and that the pair of contact arrangements, each having three contacts, illustrated in the Figures is meant to be illustrative, rather than limiting.

The base 12 includes a mounting portion 24 and a contact support portion 26 extending therefrom. The base 12 further includes a voltage barrier 28 that separates the pair of contact arrangements 16. The base 12 further includes an insert portion 30 that forms a shoulder 32 with the mounting portion 24. In one preferred embodiment, the mounting portion 24 preferably has a rectangular shape, although it should be understood that the mounting portion can have other shapes.

Referring to FIGS. 6 and 7, a cover 34 is received on the insert portion 30 and engages the shoulder 32 of the base 12 when moved to a first, installed position, wherein the cover 34 is disposed over and covers the contact arrangements 16. In one embodiment, the cover 34 forms a cavity shaped like a tub in which the contact arrangements 16 are received. The cover 34 is preferably releasably secured to the base 12 in the first position with a snap fit configuration, which includes a pair of mounting members 36, shown in FIG. 1 as spring clips. In alternative embodiments, the cover can be releasably secured to the base with other mounting members, including for example and without limitations various detents, mechanical fasteners, adhesives, hooks, hook and loop fasteners and other devices know to those of skill in the art.

In operation, the mounting member 36 can be manipulated to release the cover 34, which can be removed from, or disengaged from, the base 12 and moved to a second position so as to expose the contact arrangements 16 to the user or operator, e.g., an electrician. It should be understood that when the cover 34 is disengaged from the base 12, it does not mean that the cover is necessarily completely separated from the base. Rather, the cover can be moveably secured to the base with a hinge, lanyard or other tether device. Alternatively, the cover can be slid on the base from a releasably secured position to a disengaged position where the cover is still supported on the base, for example, by an insert portion or guide portion. Accordingly, it should also be understood that the “second position,” as used herein, means any disengaged position other than the first, completely installed position, where the cover is releasably secured to the base, and can include various positions where the cover is partially engaged with or supported by the base.

The relay 10, and in particular the base 12 thereof, is mounted to a panel or other support structure with a plurality of mounting members 38, shown as mechanical fasteners, e.g., studs. Again, it should be understood that the base 12 can be secured to the support structure with adhesives, welding, and other fastening systems know to those of skill in the art.

The relay 10 is typically integrated into a control system, or circuit, that is preferably configured to control the operation of one or more various pieces of equipment, electrical and mechanical, machinery and/or switching devices, and can have associated with it timing and/or control circuits activated by input devices, power sources, memory storage modules, display systems and or instrumentations (e.g., regulators, sensors for monitoring temperature, volume, pressure or other variables, heating and/or cooling systems), etc. For example, in one preferred embodiment, the control system implements a control program in a series of steps (which may according to alternative embodiments be implemented in a variety of other sequences and/or with a variety of other inputs, outputs, steps or instructions). The control system can be implemented with one or more digital processors and/or integrated with one or more microprocessors. The control system is not intended to be limited to any particular type of controller capable of implementing the intended functionality, and should be understood to apply to any industrial, commercial or other application using relays. Various relays suitable for use in various control systems include, for example and without limitation, the HGA11, HGA14 and HGA18 relays available from the General Electric Company.

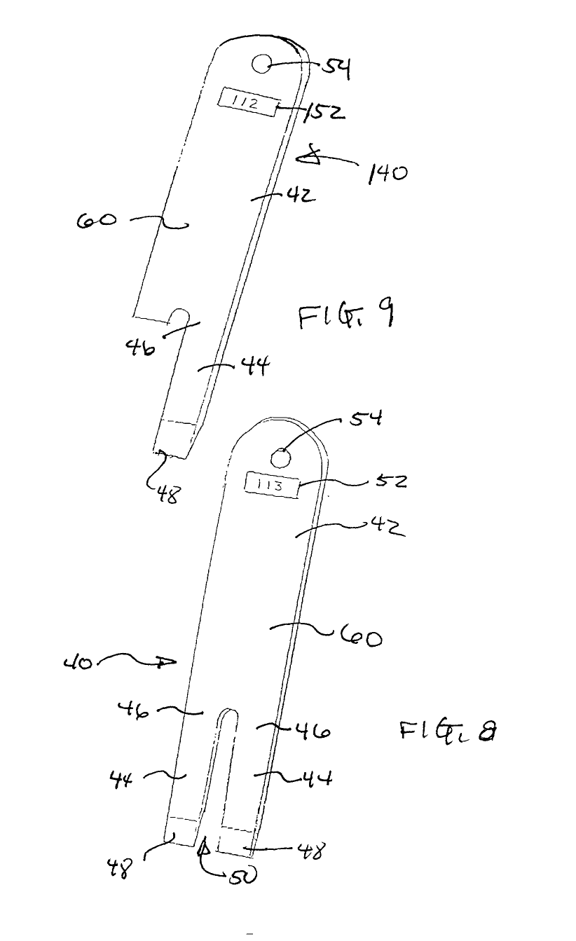

Referring to FIG. 8, a contact block 40 is shown as having a grippable portion 42 and a plurality of primary blocking portions 44 (shown as a pair of leg members) extending from the grippable portion 42. It should be understood that the contact block can be configured with more than two primary blocking portions, and that the two blocking portions are meant to be illustrative rather than limiting. The blocking portions 44 each have a first end 46 connected to the grippable portion 42 and a second end 48 spaced therefrom. The blocking portions 44 extend from the grippable portion in a substantially parallel and spaced apart relationship so as to define a space 50, configured as a slot, therebetween. The blocking portions 44 are preferably spaced such that the barrier 28 can be received therebetween in the space 50. The second, free ends 48 of the blocking portions 44 are preferably tapered so as to facilitate the insertion of the blocking portions into the contact arrangements 16.

The contact block 40 is preferably made of a pliable, non-conductive material, such as a plastic. It should be understood that other known non-conductive materials, such as wood, fiberglass would also work. In a preferred embodiment, the grippable portion 42 and the blocking portions 44 are substantially coplanar, and have a thickness of about 1/16 or 0.0625 inches. It should be understood that the grippable portion can be made with a different thickness and of a different material than the blocking portions, and may be configured with a contour that can be easily gripped by the user. It should also be understood that the grippable portion can define a plane that can be offset from a plane defined by the blocking portions, preferably with the planes being substantially parallel. It should be understood that the thickness of the contact block 40, and in particular the thickness of the blocking portions 44 can be increased or decreased depending on the size and gap formed between the contacts on the contact arrangement.

In an alternative embodiment of the contact block, shown in FIG. 9, the contact block 140 includes only a single primary blocking portion 44. The contact block can be fabricated with a single blocking portion, or the end user, if desiring only a single blocking portion, or some number of blocking portions less than the original plurality, can break, cut or otherwise sever the other primary blocking portions of the contact block so as to leave a lesser number of primary blocking members.

Referring to FIGS. 8 and 9, in a preferred embodiment, the contact block 40,140 is provided with notice indicia 52,60 that advises or notifies the user that the contact block is installed in a contact arrangement. For example, the contact blocks can be individually numbered with indicia 52,152, or provided with any other sequential listing, e.g., alpha-numeric characters, preferably on the grippable portion which is visible to the operator, such that the contact blocks 40,140 can be counted and arranged sequentially after removal. In this way, if one or more numbered contact blocks 40,140 are missing from the final count, the control system can be inspected to find the missing contact blocks.

The contact block is preferably configured with an opening 54, which allows the contact block to be stored on a post member, such as a nail. Alternatively, the contact block can be configured with a hook or other hanger member.

Alternatively, or in addition to the sequential indicia, the contact block can also be configured with a notice indicia 60 such as a bright color, that notifies the operator that the contact block remains installed in a relay. Alternatively, the contact block can be configured with a color indicia that differs from the color of the relay, and in particular, the base portion thereof. In yet another alternative, the contact block can be configured with a pattern, such as stripes, dots or other indicia, that differs from the finish of the relay so as to notify the operator about the presence of the contact block.

In operation, it is often necessary to block one or more contact arrangements 16 in a relay. For example, it is often desirable to conduct logic testing of the control systems after a plant shutdown before restarting the plant so as to ensure that the system is operating properly. It should be understood that the contact block 40,140 can be used in any application where it is necessary to block contact between two contacts, and that the use of the contact block during logic testing is meant to illustrative rather than limiting.

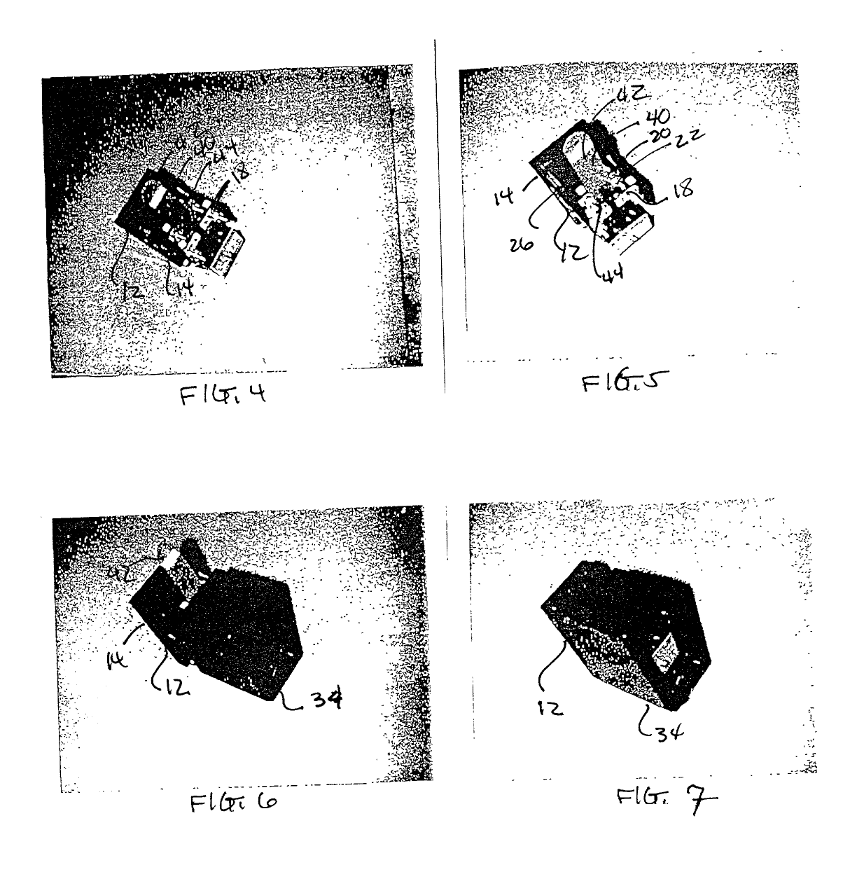

Referring to FIGS. 4-7, the cover 34 of the relay 10 is removed, or moved to a second position, such that the contact arrangements 16 are exposed. The operator then inserts the primary blocking portions 44 into the contact arrangements 16 between one of the stationary contacts 18,20 and the moveable contact 22. For example, as shown in FIG. 4, the primary blocking portions 44 are inserted on a first side of the contact between the first pair of stationary contacts 18 and a first side of the moveable contacts 22. Alternatively, as shown in FIG. 5, the primary blocking portions 44 are inserted on a second side of the contact arrangements 16 between the second pair of stationary contacts 20 and a second side of the moveable contacts 22. In either configuration, the primary blocking portions 44 are inserted in the contact arrangements 16 on opposite sides of the barrier 28, which is received in the space 50 formed between the primary blocking portions 44. The contact block 40,140 is inserted preferably by gripping the grippable portion 42 and initially inserting the tapered end portions 48 into the contact arrangements 16 between one of the stationary contacts 18,20 and the moveable contacts 22. The user can then move the primary blocking portions 44 down into the contact arrangements 16 between the contacts 18,20,22 by manipulating the grippable portion 42. In this way, the user avoids hand contact with the contact arrangements 16, and can insert the contact block from a safe distance.

When the contact block 40,140 is installed in the contact arrangements, with the primary blocking portions 44 inserted in the contact arrangements 16, the blocking portions prevent the moveable contacts 22 from contacting one of the stationary contacts 18,20. When blocking of the contacts 18,20,22 is no longer desired, for example after the logic testing is completed, the user simply grips the grippable portion 42 and removes the contact block 40,140, and in particular the blocking portions 44 from the contact arrangements 16. The cover 34 can then be releasably secured over the contact arrangements 16 in the first, installed position.

In one preferred removal sequence, the cover 34 is first aligned with respect to the base 12, and for example may be partially inserted on or may be guided by the insert portion 30 of the base 12, with the contact block 40,140 still inserted in the contact arrangements 16. Once the operator is confident that the cover 34 is properly aligned with respect to the base, the contact block 40,140 can be removed and the cover 34 can be snapped or secured in place to the base 12 over the contact arrangements 16. In this way, the contact arrangements 16 are blocked until the last possible moment before the cover 34 is installed, so as to minimize the opportunity for the contact arrangements 16 to be inadvertently activated, e.g., by bumping the contact arrangements 16 with the cover 34 as it is being installed or releaseably secured to the base 12.

In a preferred embodiment, the grippable portion 42 serves as a secondary blocking portion. In particular, the secondary blocking portion 42 extends outwardly from the contact arrangement 16 between the cover 34 and the base 12 and prevents the cover 34 from being removeably installed on the base 12 in the first position. In this way, the secondary blocking portion 42 provides an additional safeguard against inadvertently installing the cover 34 onto the relay 10 over the contact arrangement 16 with the contact block 40,140 still inserted in the contact arrangements 16, which can cause the control system to malfunction when brought back on line.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A contact block for use with an electrical relay comprising:
a grippable portion; and
a plurality of blocking portions extending from said grippable portion, wherein said plurality of blocking portions are oriented in a parallel relationship relative to each other and wherein said grippable portion and said plurality of blocking portions are substantially coplanar.

2. The invention of claim 1 wherein each of said plurality of blocking portions comprises a tapered end portion.

3. The invention of claim 2 wherein said plurality of blocking portions comprises a pair of blocking portions.

4. The invention of claim 1 wherein at least a portion of at least one of said grippable portion and said plurality of blocking portions comprises notice indicia.

5. The invention of claim 4 wherein said notice indicia comprises a bright color.

6. The invention of claim 1 wherein said plurality of blocking portions are made of a pliable material.

7. The invention of claim 6 wherein said plurality of blocking portions are made of plastic.

8. An control system comprising:
an electrical relay comprising a base, a contact arrangement supported on said base and a cover moveable between at least a first position wherein said cover is releasably secured to said base over said contact arrangement and a second position wherein said cover is disengaged from said base with said contact arrangement exposed to a user; and
a contact block comprising a primary blocking portion and a secondary blocking portion, wherein said primary blocking portion is releasably inserted into said contact arrangement and wherein said secondary blocking portion is disposed between said cover and said base when said cover is in said second position and wherein said secondary block portion prevents said cover from being moved to said first position.

9. The invention of claim 8 wherein said electrical relay comprises a first plurality of contact arrangements, and wherein said primary block portion comprises a second plurality of blocking portions extending from said secondary blocking portion, wherein said second plurality of blocking portions are arranged in a parallel relationship to each other.

10. The invention of claim 9 wherein each of said second plurality of blocking portions comprises a tapered end portion.

11. The invention of claim 9 wherein said plurality of blocking portions comprises a pair of blocking portions.

12. The invention of claim 8 wherein at least a portion of said contact block comprises notice indicia.

13. The invention of claim 12 wherein said base is a first color and wherein said notice indicia comprises a second color different than said first color.

14. The invention of claim 9 wherein said contact block is made of a pliable material.

15. The invention of claim 14 wherein said contact block is made of plastic.

16. The invention of claim 9 wherein said second plurality of blocking portions are spaced from one another and thereby define a space between adjacent blocking portions.

17. The invention of claim 16 wherein said relay comprises a barrier, wherein said barrier is removeably received in said space defined between at least two adjacent blocking portions when said blocking portions are releasably inserted into said first plurality of contact arrangements.

18. The invention of claim 8 wherein said contact arrangement comprises a stationary contact and a moveable contact biased against said stationary contact, wherein said primary blocking portion is releasably inserted between said moveable and said stationary contact.

19. A method of blocking an electrical contact arrangement comprising:
providing an electrical relay comprising a base, a contact arrangement supported on said base and a cover releasably secured to said base over said contacts;
removing said cover from said base and thereby exposing said contact arrangement;
providing a contact block comprising a primary blocking portion and a secondary blocking portion;
releasably inserting said primary blocking portion into said exposed contact arrangement and thereby blocking said contact arrangement from making an electrical connection; and
disposing said secondary blocking portion between said cover and said base wherein said secondary block portion prevents said cover from being releasably secured to said base.

20. The invention of claim 19 wherein said electrical relay comprises a first plurality of contact arrangements, and wherein said primary block portion comprises a second plurality of blocking portions extending from said secondary blocking portion, wherein said second plurality of blocking portions are arranged in a parallel relationship to each other, and wherein said releasably inserting said primary blocking portion into said exposed contact arrangement comprises simulataneously releasably inserting at lease a portion of said second plurality of said blocking portions into a corresponding portion of said first plurality of said contact arrangements.

21. The invention of claim 20 wherein each of said second plurality of blocking portions comprises a tapered end portion.

22. The invention of claim 20 wherein said plurality of blocking portions comprises a pair of blocking portions.

23. The invention of claim 19 wherein at least a portion of said contact block comprises notice indicia and further comprising notifying a user of said releasable insertion of said primary blocking portion into said exposed contact arrangement with said notice indicia.

24. The invention of claim 23 wherein said base is a first color and wherein said notice indicia comprises a second color different than said first color.

25. The invention of claim 19 wherein said contact block is made of a pliable material.

26. The invention of claim 25 wherein said contact block is made of plastic.

27. The invention of claim 20 wherein said second plurality of blocking portions are spaced from one another and thereby define a space between adjacent blocking portions.

28. The invention of claim 27 wherein said relay comprises a barrier, and wherein said releasably inserting said primary blocking portion into said exposed contact arrangement further comprises removeably inserting said barrier in said space defined between at least two adjacent blocking portions.

29. The invention of claim 19 further comprising removing said primary blocking portion from said exposed contact arrangement and installing said cover on said base over said contact arrangement

30. A method of blocking an electrical contact arrangement comprising:
providing an electrical relay comprising a base, at least a pair of spaced apart contact arrangements;
providing a contact block comprising a grippable portion and a plurality of blocking portions extending from said grippable portion, wherein said plurality of blocking portions are oriented in a parallel relationship relative to each other and wherein said grippable portion and said plurality of blocking portions are substantially coplanar; and
releasably inserting at least a pair of said plurality of blocking portions into said at least said pair of contact arrangements and thereby blocking said at least said pair of contact arrangements from making an electrical connection.

31. The invention of claim 30 wherein each of said plurality of blocking portions comprises a tapered end portion and wherein said releasably inserting said at least said pair of said plurality of blocking portions into said at least said pair of contact arrangements comprises inserting said tapered end portion into said at least said pair of said contact arrangements.

32. The invention of claim 30 wherein said plurality of blocking portions comprises a pair of blocking portions.

33. The invention of claim 30 wherein at least a portion of said contact block portions comprises notice indicia.

34. The invention of claim 33 wherein said base is a first color and wherein said notice indicia is a second color, wherein said second color is different than said first color.

35. The invention of claim 1 wherein said contact block is made of a pliable material.
